(19) United States
(12) Patent Application Publication
(10) Pub. No.: US 2017/0255506 A1
(43) Pub. Date: Sep. 7, 2017

(54) MONITORING, ANALYZING, AND MAPPING OF COMPUTING RESOURCES

(71) Applicant: Dell Software, Inc., Round Rock, TX (US)

(72) Inventors: Manoj Gujarathi, Austin, TX (US); Brent Schroeder, The Hills, TX (US); Tom W Kendra, Addison, TX (US)

(73) Assignee: Dell Software, Inc.

(21) Appl. No.: 15/062,905

(22) Filed: Mar. 7, 2016

(51) Int. Cl. G06F 11/07; G06F 11/34

(52) U.S. Cl. CPC G06F 11/079; G06F 11/0751; G06F 11/0787; G06F 11/3409

(57) ABSTRACT

Systems and techniques for dynamic monitoring, analysis and mapping of resources are described. Monitoring data can be obtained from a variety of different sources, such as operating systems, applications, hardware interfaces, and the like. In addition to obtaining monitoring data, health data can also be obtained for one or more of the computing resources. After obtaining the monitoring data and the health data, the monitoring data and health data may be used to determine whether a computing environment has computing resources available to meet the needs for a workflow. Instead of waiting for a failure event to occur, a user can be proactively informed that computing resources utilized, or computing resources that may be utilized by the workflow are experiencing health issues and/or not available within a computing environment.

### BACKGROUND

Today, there are many different monitoring tools available to perform software and hardware monitoring. Generally, the monitoring tools gather data provided by an in-band agent that talks to operating systems that obtains the monitoring data. The monitoring data might include information such as memory utilization, CPU utilization, disk usage, network usage, and the like. While these monitoring tools may provide data that can be used for analytics, trends, and capacity forecasts, there is a large amount of data related to hardware and software resources that may be helpful to users but is difficult to obtain.

### SUMMARY

This Summary provides a simplified form of concepts that are further described below in the Detailed Description. This Summary is not intended to identify key or essential features and should therefore not be used for determining or limiting the scope of the claimed subject matter.

Systems and techniques for dynamic monitoring, analysis and mapping of computing resources are described. Monitoring data can be obtained from a variety of different sources, such as operating systems, applications, hardware interfaces, and the like. The monitoring data for computing resources may indicate memory utilization, CPU utilization, disk usage, network, and the like. In addition to obtaining monitoring data, health data can also be obtained for one or more of the computing resources. For example, the health data may indicate whether or not a particular hardware device has a fault condition, whether a redundant hardware device that may be utilized by a workflow is operating properly, and the like.

After obtaining the monitoring data and the health data, the monitoring data and health data may be used and programmatically analyzed to determine whether a computing environment has computing resources available to meet the needs for a workflow. For example, if a workflow requires a specified amount of memory and a portion of the memory is experiencing health issues, then a software application, or some other component or device can proactively perform an action. For example, the application or component may allocate additional memory, change the location of the memory utilized by the workflow, and/or notify a user of the problem with a required computing resource. Instead of waiting for a failure event to occur, a user can be proactively informed that computing resources utilized, or computing resources that may be utilized by the workflow are experiencing health issues and/or not available within a computing environment. In this way, the user, or an automated process, may determine whether or not to move the workflow and/or obtain additional computing resources to meet the requirements of the workflow.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram illustrating a computing system that includes software to monitor, analyze and map computing resources according to some examples.

FIG. 2 is a block diagram illustrating a graphical user interface (GUI) that shows a sample map according to some examples.

FIG. 3 is a flowchart of a process that includes operations relating to identifying resources and generating a map of computing resources according to some examples.

FIG. 4 is a flowchart of a process that includes obtaining monitoring data, health data and adjusting deployment of computing resources according to some examples.

FIG. 5 is a flowchart of a process that includes providing a dashboard for display on a computing device according to some examples.

FIG. 6 illustrates an example configuration of a computing device that can be used to implement the systems and techniques described herein.

### DETAILED DESCRIPTION

For purposes of this disclosure, a computing environment may include computing resources, or any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a computing environment may include one or more personal computers (e.g., desktop or laptop), tablet computers, mobile devices (e.g., personal digital assistant (PDA) or smart phone), servers (e.g., blade server or rack server), network storage devices, or any other suitable devices and may vary in size, shape, performance, functionality, and price. The computing environment may include random access memory (RAM), one or more processing resources such as a central processing unit (CPU) or hardware or software control logic, ROM, and/or other types of nonvolatile memory. Additional components of a computing environment may include one or more disk drives, one or more network ports for communicating with external devices as well as various input and output (I/O) devices, such as a keyboard, a mouse, touchscreen and/or video display. The computing environment may also include one or more buses operable to transmit communications between the various hardware components. In some configurations, the computing environment may utilize virtual machines (VMs), containers, or some other type of virtualized computing resource.

As discussed briefly above, systems and techniques are described herein for dynamic monitoring, analysis and mapping of computing resources within a computing environment. Instead of obtaining and analyzing monitoring data from a single source, monitoring data and health data is obtained from a variety of different sources. For example, monitoring data may be obtained from various monitoring services, operating systems, applications, hardware interfaces, and the like. In addition to obtaining monitoring data, health data can also be collected for the computing resources. For example, the health data may indicate whether or not a particular hardware device has a fault condition, whether a redundant hardware device that may be utilized by a workflow is operating properly, and the like.

After obtaining the monitoring data and the health data, a mapping manager (e.g., a software application) may analyze the monitoring data and health data to determine whether the available resources of a particular computing environment meet the computing resource needs for one or more workflows. A “workflow” can refer to a series of activities to complete a task. Some or all of these tasks may be performed by computing resources. In some configurations, a workflow can specify computing resources that are required. For example, a workflow may specify that it needs a specified amount of memory, that it requires redundant memory and that it utilizes eight processors.

At some time during execution of the workflow, the mapping manager may determine from the monitoring data and/or health data that a requirement is experiencing health issues and/or is not available within the computing environment. In response, the mapping manager can proactively take action. For example, the mapping manager can allocate additional memory, change the location of the memory utilized by the workflow, move a process, and/or notify a user of the problem with a required computing resource. Instead of waiting for a failure event to occur, the mapping manager may proactively inform a user that resources utilized, or may be utilized by the workflow are experiencing health issues. In this way, the user, or an automated process, may determine whether or not to move the workflow and/or obtain additional resources to meet the requirements of the workflow.

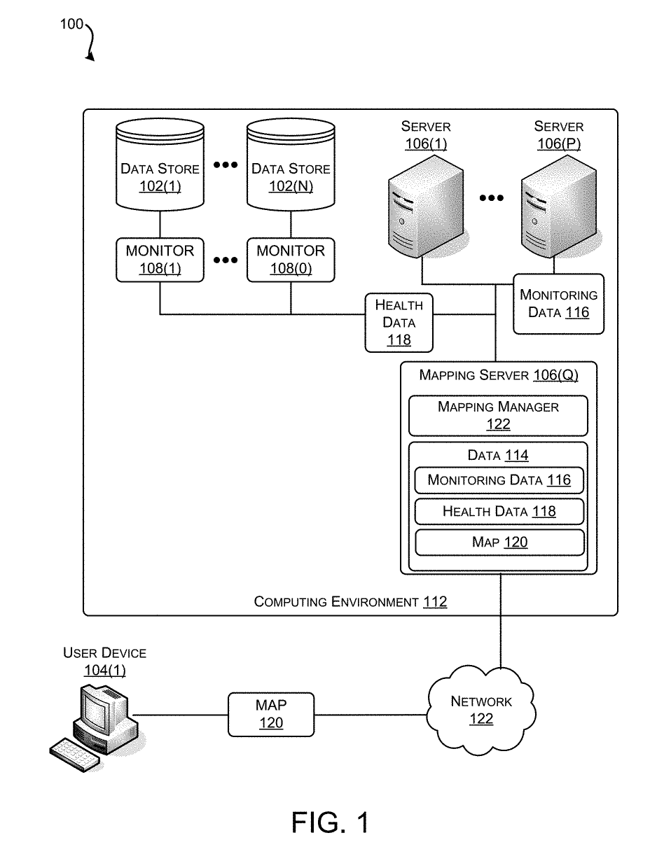

FIG. 1 is a block diagram illustrating a computing system 100 that includes software to monitor, analyze and map computing resources according to some examples. The computing system 100 may include multiple types of network elements, including a representative one or more data stores, such as a data store 102(1) to a data store 102(N), a representative one or more monitors, such as monitor 108(1) to a monitor 108(0), a representative one or more user devices, such as a user device 104(1), a representative one or more servers, such as a server 106(1) to a server 106(Q), where N>1, O>1, P>0, and Q>1, and where N, O, P, and Q are not necessarily the same value. Of course, the computing system 100 may include other network elements besides the data stores 102, the user devices 104, the monitors 108, and the servers 106. The user devices 104 may include workstations, laptops, tablets, wireless phones, other types of computing devices used to access other network elements of the computing system 100, or any combination thereof.

One or more of the network elements of the computing system 100 may have an associated monitor that gathers data for one or more of the components. In some configurations, the monitors 108 can monitor operational characteristics of one or more computing resources and/or health characteristics for one or more of the computing resources. For example, the monitoring data 116 may indicate memory utilization, CPU utilization, disk usage, network usage, and the like for computing resources. In addition to obtaining monitoring data 116, health data 118 can also be obtained for the computing resources. The health data 118 may indicate whether or not a particular hardware device has a fault condition, whether a redundant hardware device that may be utilized by a workflow is operating properly, and the like. The monitors 108 may obtain data from one or more sources. For example, a monitor 108 can receive monitoring data 116 and/or health data 118 from an operating system, from the hardware itself (e.g., through an interface such as an Application Programming Interface (API)), or from some other location. A monitor 108 can be implemented as a hardware computing resource and/or a software computing resource (e.g., a software application).

A monitor 108 can store data within one or more of the data stores 102. For example, each of the monitors 108(1) to 108(0) may be associated with a particular one of the data stores 102(1) to 102(N) (e.g., the monitor 108(1) may be associated with the data store 102(1) and the monitor 108(0) may be associated with the database 102(N)). The monitors 108 may also communicate with the mapping server 106(Q) which can store the data 114 as monitoring data 106(Q) and health data 118. In some configurations, a monitor 108 may be associated with a particular one of the servers 106(1) to 106(P) or a group of servers. According to some configurations, the monitoring data 116 and the health data 118 includes data obtained from hardware resources that operating systems typically do not have access to. For example, data may be collected one or more monitors 108 relating to redundant memory failing, power supply losing redundancy, hidden CPU state change, FRUs (field replaceable units) failures, and the like. Additional hardware components can include, but are not limited to chassis' common hardware components such as IOA (IO Aggregators), network fabrics, switches as well as the underlying integration of those components.

A mapping server 106(Q) can receive data 114 from one or more of the monitors 108 via a network (wired or wireless). The mapping server 106(Q) may store at least a portion of the data 114 in a data store. For example, the mapping server 106(Q) may store some or all of the data 114 received from one or more of the monitors 108. The mapping server 106(Q) may include one or more processors and one or more computer readable storage media to store mapping manager 122. The mapping manager 122 may be executed by the one or more processors of the mapping server 106(Q) to perform various functions. For example, the mapping manager 122 may perform operations relating to monitoring, analyzing, and mapping of computing resources.

After obtaining the monitoring data 116 and the health data 118 from the monitors 108, a mapping manager 122 may programmatically (e.g. without user interaction) analyze the monitoring data and health data to determine whether the available resources of a computing environment 112 (or some other computing environment) meet the computing resource needs for one or more workflows. A “workflow” can refer to a series of activities to complete a task. Some or all of these tasks may be performed by computing resources. In some configurations, a workflow can specify computing resources that are required. For example, a workflow may specify that it needs a specified amount of memory and redundant memory.

As an example, at some time during execution of the workflow, the mapping manager 122 may determine from the monitoring data and/or health data that a computing resource is experiencing health issues. In response, the mapping manager 122 can proactively perform an action to address the issue. For instance, the mapping manager 122 may allocate one or more additional computing resources and/or notify a user of the problem with a required computing resource. Instead of waiting for a failure event to occur, the mapping manager 122 proactively informs a user that computing resources utilized, or may be utilized by the workflow are experiencing health issues. In this way, the user, or an automated process, may determine whether or not to move the workflow and/or obtain additional resources to meet the requirements of the workflow.

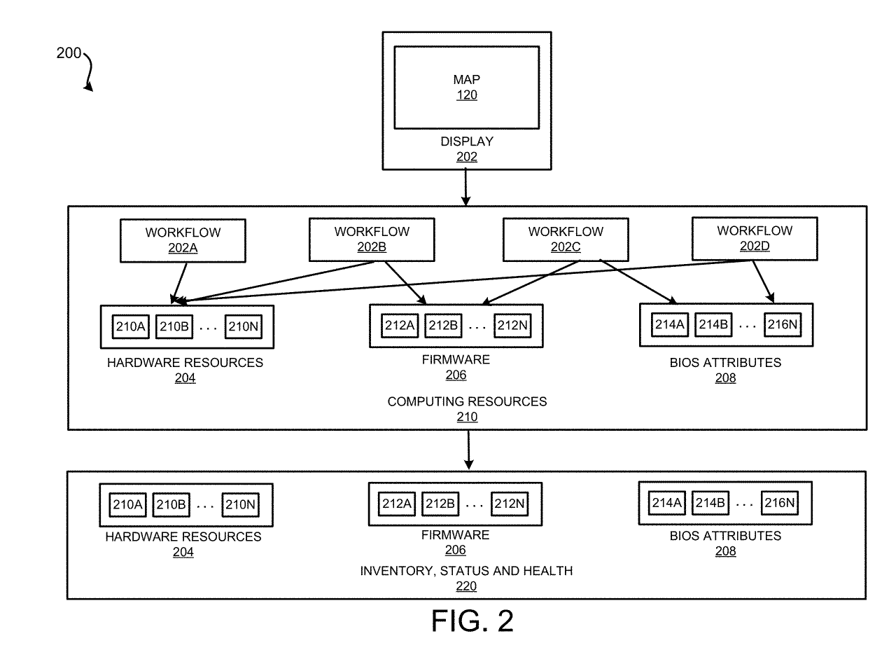

In some examples, the mapping manager 122 maintains information about workflows, critical resource needs for the workflow, and availability of the computing resources along with the monitoring data and health data for the computing resources. The mapping manager 122 can create a map 120 that shows the mapping of the computing resources associated with a particular workflow, monitoring data 116, health data 118, and recommendations associated with the workflow. An exemplary map 120 is illustrated in FIG. 2.

FIG. 2 is a block diagram illustrating a graphical user interface (GUI) 200 that shows a sample map 120 according to some examples. For example, the mapping manager 122 may analyze the monitoring data, the health data, and the available computing resources, generate the map 120, and display the GUI 200 including the map 120 on a display device of a user.

According to some configurations, the mapping manager 122 creates a dynamic relationship map 120 that provides an overview of the computing resources 210 associated with one or more workflows 202. In the current example, the map 120 includes a mapping of resources utilized by workflow 202A, 202B, 202C and 202D. More or less workflows 202 may be included in a map. As illustrated, the map 120 shows what workflows are associated with hardware resources 204 (e.g. memory redundancy, power supply), firmware resources 206 (ambient temperature, fan speeds, security attributes, TPM (Trusted Platform Module) state, TXT, FRM (Fault Resiliency Memory by DELL) availability) and bios attributes 208 (FRM state, Virtualization mode, boot mode).

The mapping manager 122 creates the map 120 by including both resource health information determined from the health data 118 and performance analytics determined from the monitoring data 120 to create the dependency map 120 between application performance and performance dependent hardware resources, such as memory, CPUs, system busses and disks. The mapping manager 122 may also include hardware events which are invisible to the host operating system and applications in both root cause analysis of performance degradation as well as predictive analytics to avoid an impending performance issue.

According to some configurations, the mapping manager 122 identifies workflows 202 running within one or more computing environments, such as the computing environment 112, and determines the computing resources 210 that are associated with those workflows 202. In some examples, the mapping manager 122 can access a definition for the workflow 202 that identifies the resources utilized. In other examples, the service may determine the resources utilized by a workflow 202 based on use of the resources during different times. Stated another way, the resources may be determined by a historical running of the workflow 202. In some examples, a hypervisor or VMM (virtual machine manager) may provide this information.

According to some configurations, the mapping manager 122 provides a map 120 on a display 202 that can be customized by a user. For example, a user may select what resources to display, what resources are critical, what information to show on the map 120, and the like. This mapping can also include capabilities that may be unique to a particular company (e.g., FRM) that OS is not aware of, or other security attributes such as Trusted Execution Technology (TXT) by INTEL or Trusted Platform Module (TPM) technology. In some configurations, an authorized user can determine the resources that are critical. For example, a user may specify that power supply redundancy is required, or micro level attributes like ambient temperature, or a number of mezzanine network cards are required.

After determining the resources utilized by the workflow, the mapping manager 122 can construct a dynamic mapping table of those resource needs to the resource availability on the host hardware. The host hardware may include one or more computing devices. In some examples, the host hardware may be provided by a network provider service, such as Cloud Computing by DELL. According to some configurations, the mapping manager 122 creates a graphical display (e.g., as illustrated in FIG. 2) that shows critical resources that are available and those that are not available. This information can be provided as a dashboard within a Graphical User Interface (GUI) to the user. For example, the inventory, status, and health display area 220 may include graphical indicators (e.g., 210A-210N, 212A-212N, and 214A-214N) that the mapping manager 122 updates based on the monitoring data 116 and/or the health data 118 associated with the respective resource. In some examples, the map 120 may be coded to provide the user with a way to easily discern healthy resources from non-healthy resources. For example, a graphical block (e.g., block 210A) may change colors based on the state of the resource (e.g., green operating normally, red not operating, grey not present in computing environment). The map 120 could add the readings on certain sensors and based on the status, provide health on the sensors—is ambient temperature below 65 degrees.

As an example, workflow 202A may require dual power supply redundancy, a host with 8 CPU sockets, and TPM—mapped to what the host having these resources based on the inventory from out of band agent (like an integrated Dell Remote Acces Controller (iDRAC) by DELL, Inc.) an have those turned on (through BIOS or Firmware). Before execution of the workflow, the mapping manager 122 can provide the user with information relating to whether or not there are available computing resources that have the specified requirements (e.g., dual power supply redundancy, a host with 8 CPU sockets, and TPM). After the execution of the workflow, the mapping manager 122 can monitor the workflow to determine if the required resources are still healthy and available. When the resources are not available, the mapping manager 122 can inform the user and/or move the workflow to other available computing resources.

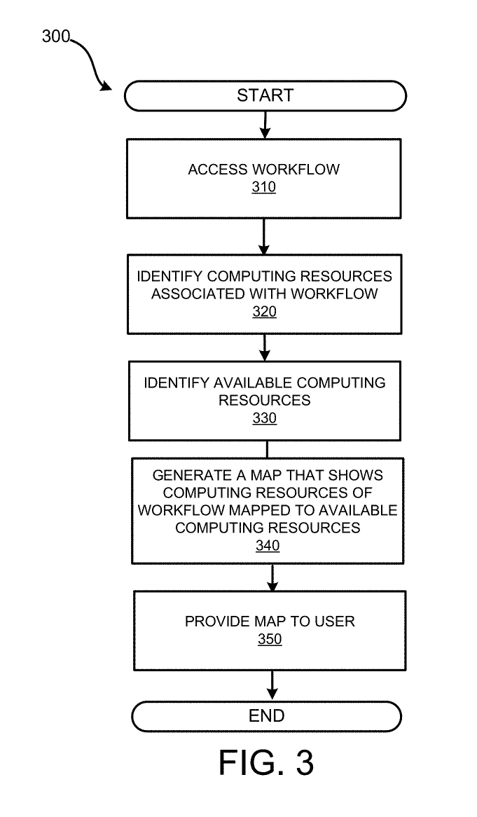

In the flow diagrams of FIGS. 3, 4, and 5, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 300, 400, and 500 are described with reference to FIGS. 1 and 2 as described above, although other models, frameworks, systems and environments may implement these processes.

FIG. 3 is a flowchart of a process 300 that includes operations relating to identifying resources and generating a map of computing resources according to some examples. The process 300 may be performed by a software application, such as the mapping manager 122 of FIG. 1.

At 310, a workflow is accessed. As discussed above, a workflow includes associated computing resources that perform operations relating to the workflow. In some configurations, the workflow is created by a user and stored within a data store 102. According to some examples, the workflow can identify an importance of computing resources within the workflow. For instance, a user can specify the computing resources that should be available while a task is being performed.

At 320, the computing resources associated with the workflow are identified. The computing resources may be identified by a historical determination of the computing resources utilized by the workflow or by specified computing resources within a file or some other location. For example, when a workflow is run within a computing environment, the mapping manager 120 may determine the computing resources being utilized while the workflow is running. In other examples, the computing resources can be specified by a user and stored within a memory or data store 102.

At 330, available computing resources of the computing environment are identified. As discussed above, the available computing resources of the computing environment may be determined by the mapping manager 122, a computing device or some other application or component. In some examples, the available computing resources may be virtual computing resources such as VMs, or containers.

At 340, a map is generated that shows computing resources of the workflow mapped to available computing resources of the computing environment. As discussed above, the map 120 can be used by user to view computing resources associated with workflow as well as available computing resources within the computing environment.

At 350, the map may be provided to the user. As discussed above, the map 120 may include monitoring data 116, health data 118, recommendations, as well as other data that may be used by the user in determining characteristics of the workflow while executing in the computing environment.

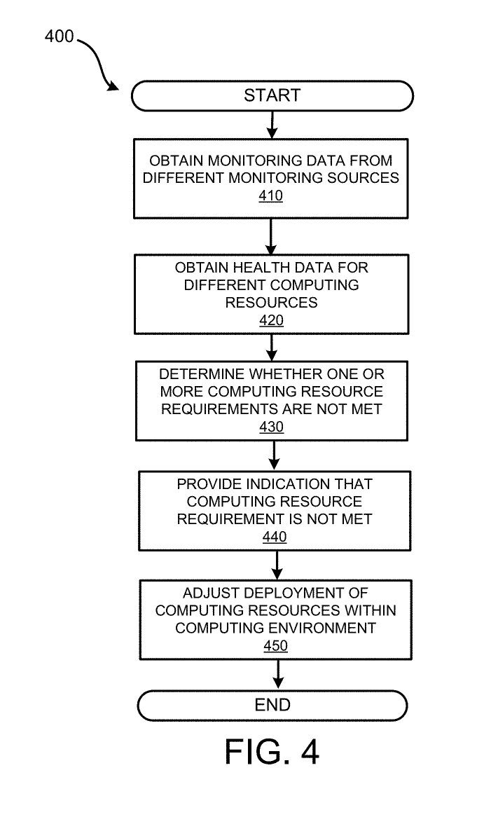

FIG. 4 is a flowchart of a process 400 that includes obtaining monitoring data 116, health data 118 and adjusting deployment of computing resources according to some examples. The process 400 may be performed by a software application, such as the mapping manager 122 of FIG. 1.

At 410, monitoring data 116 is obtained from different monitoring sources. As discussed above, instead of just obtaining monitoring data 116 from a single monitoring service, monitoring data 116 can be obtained from a variety of different sources. For example the monitoring data 116 may include data available to the operating system and/or data available from computer hardware and/or other resources.

At 420, health data 118 for the different computing resources is obtained. As discussed above, in addition to obtaining monitoring data 116 for a particular computing resource, health data 118 for that computing resource may also be obtained. Including both monitoring data 116 and health data 118 provides additional information to a user that can assist the user, or a computing device, when determining how a workflow is executing. In some examples, the health data 118 may provide health information for redundant computing resources.

At 430, a determination is made as to whether one or more computing resource requirements are not met. As discussed above, a computing requirement for workflow may specify different characteristics such as, but not limited to requirement of one or more redundant computing resources and/or operational characteristics associated with the computing resources.

At 440, an indication is provided that the requirement is not met. As discussed above, the mapping manager 122 may provide a user indication that a requirements of the workflow is not met or may not be met in the future. For example, the mapping manager 122 may provide the user with an indication that a redundant computing resource is no longer available, and/or that a temperature of a computing device is exceeding a specified threshold.

At 450, the deployment of the computing resources within the computing environment may be adjusted. As discussed above, an authorized user may specify to move computing resources based on the available computing resources within the computing environment. Or alternatively, the mapping manager 122 may provide a recommendation to move the computing resources and/or may move the computing resources on behalf of the user without user interaction.

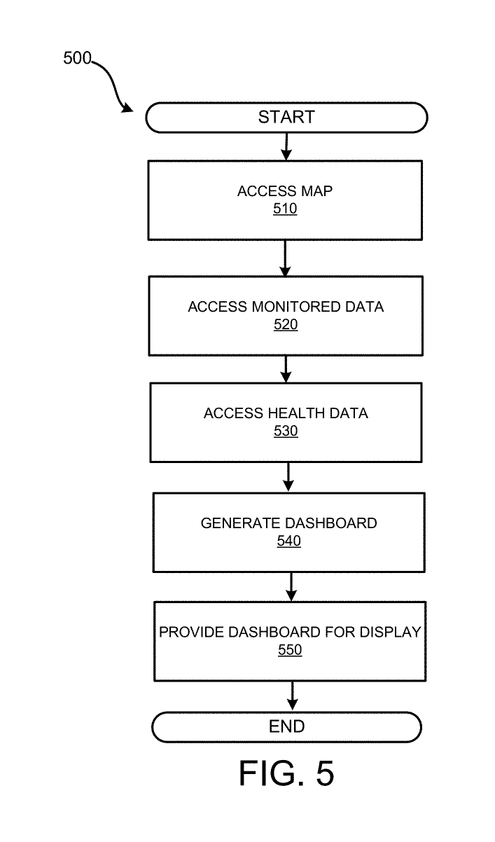

FIG. 5 is a flowchart of a process 500 that includes providing a dashboard (e.g., a GUI) for display on a computing device according to some examples. The process 500 may be performed by a software application, such as the mapping manager 122 of FIG. 1.

At 510, the map 120 for one or more workflows is accessed. As discussed above, the map provides information associated with the computing resources of a workflow. The computing resources may also include critical computing resources, as well as other characteristics associated with the computing resources for the workflow.

At 520, the monitoring data 116 is accessed. As discussed above, the monitoring data 116 relates to operational characteristics of the computing resources within the computing environment. In some examples, the mapping manager 122 obtains the monitoring data 116 from one or more monitors 108.

At 530, the health data 118 is accessed. As discussed above, the health data 118 may relate to the health of a computing resource and/or the availability of a computing resource. In some examples, the mapping manager 122 obtains the health data 118 from one or more monitors 108.

At 540, a dashboard is generated. As discussed above, the mapping manager 122 may generate the dashboard that is presented to a user. In some examples, the dashboard includes information relating to the computing resources, the available computing resources, as well as other information related to one or more workflows. According to some examples, the mapping manager 122 can provide instructions to a web browser or some other application to construct the dashboard.

At 550, the dashboard is provided for display. As discussed above, the dashboard may be presented as a GUI on a display for an authorized user.

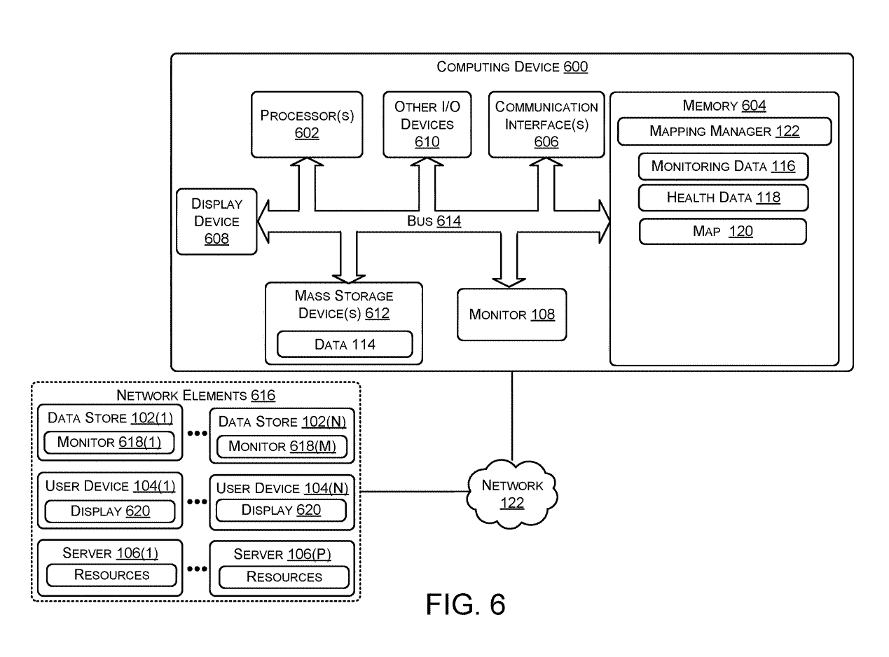

FIG. 6 illustrates an example configuration of a computing device that can be used to implement the systems and techniques described herein, such as to implement the mapping server 106(Q) of FIG. 1. The computing device 600 may include at least one processor 602, a memory 604, communication interfaces 606, a display device 608, other input/output (I/O) devices 610, and one or more mass storage devices 612, configured to communicate with each other, such as via a system bus 614 or other suitable connection.

The processor 602 is a hardware device that may include a single processing unit or a number of processing units, all of which may include single or multiple computing units or multiple cores. The processor 602 can be implemented as one or more microprocessors, microcomputers, microcontrollers, digital signal processors, central processing units, state machines, logic circuitries, and/or any devices that manipulate signals based on operational instructions. Among other capabilities, the processor 602 can be configured to fetch and execute computer-readable instructions stored in the memory 604, mass storage devices 612, or other computer-readable media.

Memory 604 and mass storage devices 612 are examples of computer storage media (e.g., memory storage devices) for storing instructions which are executed by the processor 602 to perform the various functions described above. For example, memory 604 may generally include both volatile memory and non-volatile memory (e.g., RAM, ROM, or the like) devices. Further, mass storage devices 612 may include hard disk drives, solid-state drives, removable media, including external and removable drives, memory cards, flash memory, floppy disks, optical disks (e.g., CD, DVD), a storage array, a network attached storage, a storage area network, or the like. Both memory 604 and mass storage devices 612 may be collectively referred to as memory or computer storage media herein, and may be a media capable of storing computer-readable, processor-executable program instructions as computer program code that can be executed by the processor 602 as a particular machine configured for carrying out the operations and functions described in the implementations herein.

The computing device 600 may also include one or more communication interfaces 606 for exchanging data via the network 122 with network elements 616. The communication interfaces 606 can facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, cellular, satellite, etc.), the Internet and the like. Communication interfaces 606 can also provide communication with external storage (not shown), such as in a storage array, network attached storage, storage area network, or the like. The network elements 616 may include the data stores 102, the user devices 104, and the server devices 106. Each of the network elements 616 may include a unique device identifier, such as an IP identifier or other unique device identifier. For example, each of the data stores 102, user devices 104 and each of the servers 106 can include a corresponding identifier.

A display device 608, such as a display 620 may be included in some implementations for displaying information and images to users. Other I/O devices 610 may be devices that receive various inputs from a user and provide various outputs to the user, and may include a keyboard, a remote controller, a mouse, a printer, audio input/output devices, and so forth.

The computer storage media, such as memory 604 and mass storage devices 612, may be used to store software and data. For example, the computer storage media may be used to store the mapping manager 122 of FIG. 1, monitoring data 116, health data 118, and map 120. One or more monitors 108 can also be included within the computing device 600.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Software modules include one or more of applications, bytecode, computer programs, executable files, computer-executable instructions, program modules, software code expressed as source code in a high-level programming language such as C, C++, Perl, or other, a low-level programming code such as machine code, etc. An example software module is a basic input/output system (BIOS) file. A software module may include an application programming interface (API), a dynamic-link library (DLL) file, an executable (e.g., .exe) file, firmware, and so forth.

Processes described herein may be illustrated as a collection of blocks in a logical flow graph, which represent a sequence of operations that can be implemented in hardware, software, or a combination thereof. In the context of software, the blocks represent computer-executable instructions that are executable by one or more processors to perform the recited operations. The order in which the operations are described or depicted in the flow graph is not intended to be construed as a limitation. Also, one or more of the described blocks may be omitted without departing from the scope of the present disclosure.

Although various examples of the method and apparatus of the present invention have been illustrated herein in the Drawings and described in the Detailed Description, it will be understood that the invention is not limited to the examples disclosed, but is capable of numerous rearrangements, modifications and substitutions without departing from the scope of the present disclosure.

What is claimed is:

1. A computer-implemented method, comprising:
accessing a workflow that utilizes computing resources to perform actions within a computing environment;
obtaining, from different sources, monitoring data for at least a portion of the computing resources, the monitoring data identifying one or more operational characteristics of the computing resources;
obtaining health data for the at least the portion of the computing resources, the health data identifying health characteristics of one or more hardware computing resources;
identifying, based at least in part on the monitoring data and the health data, that a specified computing resource requirement of the workflow is not met; and
providing, to a computing device, an indication that the computing resource requirement is not met.

2. The computer-implemented method of claim 1, further comprising identifying the computing resources based, at least in part, on a determination of computing resources utilized by the workflow when executed within the computing environment.

3. The computer-implemented method of claim 1, further comprising determining available computing resources within the computing environment and mapping the computing resources to the available computing resources.

4. The computer-implemented method of claim 1, further comprising identifying one or more of the computing resources as a critical resource for the workflow and determining that the critical computing resource is available within the computing environment.

5. The computer-implemented method of claim 1, further comprising identifying one or more redundant computing resources based, at least in part, on a user-specified setting.

6. The computer-implemented method of claim 1, further comprising providing, for display on a computing device, a graphical user interface that includes one or more display elements representing one or more of the computing resources, availability of the one or more computing resources, and a health of the one or more computing resources within the computing environment.

7. The computer-implemented method of claim 1, further comprising moving at least a portion of the computing resources associated with the workflow to one or more different computing resources based, at least in part, on identifying that the specified computing resource requirement of the workflow is not met.

8. A non-transitory computer-readable media storing instructions that are executable by one or more processors to perform operations comprising:
obtaining monitoring data for at least a portion of computing resources associated with a workflow, the monitoring data identifying one or more operational characteristics of the computing resources;
obtaining health data for the at least the portion of the computing resources, the health data identifying health characteristics of one or more hardware computing resources, wherein the health data includes data about one or more of firmware or BIOS attributes;
identifying, based at least in part on the monitoring data and the health data, that a specified computing resource requirement of the workflow is not met; and
providing an indication that the computing resource requirement is not met.

9. The non-transitory computer-readable media of claim 8, further comprising identifying the computing resources based, at least in part, on requirements specified by the workflow.

10. The non-transitory computer-readable media of claim 8, further comprising determining available computing resources within a computing environment and mapping the computing resources to the available computing resources.

11. The non-transitory computer-readable media of claim 8, further comprising identifying one or more critical computing resources for the workflow.

12. The non-transitory computer-readable media of claim 8, further comprising identifying specifying one or more of the computing resource as a redundant computing resource, and monitoring the redundant computing resource.

13. The non-transitory computer-readable media of claim 8, further comprising providing, for display on a computing device, a graphical user interface that includes one or more display elements representing one or more of the computing resources, availability of the one or more computing resources, and a health of the one or more computing resources within the computing environment.

14. The non-transitory computer-readable media of claim 8, further comprising moving at least a portion of the computing resources associated with the workflow to one or more different computing resources based, at least in part, on identifying that the specified computing resource requirement of the workflow is not met.

15. A server, comprising:
one or more processors; and
one or more non-transitory computer-readable media storing instructions that are executable by the one or more processors to perform operations comprising:
accessing a workflow that utilizes computing resources to perform actions within a computing environment;
obtaining monitoring data for at least a portion of the computing resources from different sources, the monitoring data identifying one or more operational characteristics of the computing resources;
obtaining health data for the at least the portion of the computing resources, the health data identifying health characteristics of one or more hardware computing resources;
identifying, based at least in part on the monitoring data and the health data, that a specified computing resource requirement of the workflow is not met; and
providing an indication that the computing resource requirement is not met.

16. The server of claim 15, further comprising identifying the computing resources based, at least in part, on a previous execution of the workflow within the computing environment.

17. The server of claim 15, further comprising mapping the computing resources to available computing resources within the computing environment.

18. The server of claim 15, further comprising determining that the one or more critical computing resources are available within the computing environment.

19. The server of claim 15, further comprising providing, for display on a computing device, a graphical user interface that includes display elements representing one or more of the computing resources, availability of the one or more computing resources, and a health of the one or more computing resources within the computing environment.

20. The server of claim 15, further comprising moving at least a portion of the computing resources associated with the workflow to one or more different computing resources based, at least in part, on identifying that the specified computing resource requirement of the workflow is not met
